(19) United States
(12) Patent Application Publication
(10) Pub. No.: US 2014/0293484 A1
(43) Pub. Date: Oct. 2, 2014

(54) DISK CLAMP WITH FLANGES

(71) Applicant: SEAGATE TECHNOLOGY LLC, Cupertino, CA (US)

(72) Inventors: Lynn Bich-Quy Le, San Jose, CA (US); Hans Leuthold, Santa Cruz, CA (US); Troy M. Herndon, San Jose, CA (US); Paco Gregor Flores, Felton, CA (US); Matthew M. McConnell, Scotts Valley, CA (US)

(73) Assignee: SEAGATE TECHNOLOGY LLC, Cupertino, CA (US)

(21) Appl. No.: 13/853,954

(22) Filed: Mar. 29, 2013

(51) Int. Cl. G11B 17/028; G11B 5/012

(52) U.S. Cl. CPC G11B 17/0284; G11B 5/012
USPC 360/99.12

(57) ABSTRACT

Provided herein is an apparatus, including a plurality of flanges extending to form an inner perimeter of an inner opening of an annular disk clamp; and an annular groove in an outer perimeter of a hub configured to receive the plurality of flanges of the annular disk clamp, wherein the disk clamp is seated above at least one disk when clamping the at least one disk onto the hub at a mounting point for the at least one disk.

### BACKGROUND

A hard disk drive (“HDD”) includes one or more disks for storing digital data, which one or more disks are clamped to a spindle motor assembly for rotation during read-write operations. The conventional, screw-based disk clamp that is used to clamp the one or more disks to the spindle motor assembly requires a dedicated space for the clamp and the one or more screws used to fasten the disks to the spindle motor assembly. The height of the dedicated space required for the screw-based disk clamp takes an amount of length away from the bearing span of the spindle.

### SUMMARY

Provided herein is an apparatus, including a plurality of flanges extending to form an inner perimeter of an inner opening of an annular disk clamp; and an annular groove in an outer perimeter of a hub configured to receive the plurality of flanges of the annular disk clamp, wherein the disk clamp is seated above at least one disk when clamping the at least one disk onto the hub at a mounting point for the at least one disk.

These and other aspects and features of the invention may be better understood with reference to the following drawings, description, and appended claims.

### DRAWINGS

FIG. 1A provides a disk clamp in accordance with an embodiment.

FIG. 1B provides a disk clamp clamping a disk onto a hub in accordance with an embodiment.

FIG. 1C provides a tool operating on a disk clamp to clamp a disk onto a hub in accordance with an embodiment.

FIG. 2A provides a disk clamp in accordance with an embodiment.

FIG. 2B provides a disk clamp clamping a disk onto a hub in accordance with an embodiment.

FIG. 2C provides a tool operating on a disk clamp to clamp a disk onto a hub in accordance with an embodiment.

FIG. 3 provides a conventional HDD in which embodiments of one or more disk clamps may be used.

### DESCRIPTION

Before embodiments of the invention are described in greater detail, it should be understood by persons having ordinary skill in the art to which the invention pertains that the invention is not limited to the particular embodiments described and/or illustrated herein, as elements in such embodiments may vary. It should likewise be understood that a particular embodiment described and/or illustrated herein has elements which may be readily separated from the particular embodiment and optionally combined with any of several other embodiments or substituted for elements in any of several other embodiments described herein.

It should also be understood by persons having ordinary skill in the art to which the invention pertains that the terminology used herein is for the purpose of describing embodiments of the invention, and the terminology is not intended to be limiting. Unless indicated otherwise, ordinal numbers (e.g., first, second, third, etc.) are used to distinguish or identify different elements or steps in a group of elements or steps, and do not supply a serial or numerical limitation on the elements or steps of the claimed invention, or embodiments thereof. For example, “first,” “second,” and “third” elements or steps need not necessarily appear in that order, and the claimed invention, or embodiments thereof, need not necessarily be limited to three elements or steps. It should also be understood that, unless indicated otherwise, any labels such as “left,” “right,” “front,” “back,” “top,” “bottom,” “forward,” “reverse,” “clockwise,” “counter clockwise,” “up,” “down,” or other similar terms such as “upper,” “lower,” “aft,” “fore,” “vertical,” “horizontal,” “proximal,” “distal,” and the like are used for convenience and are not intended to imply, for example, any particular fixed location, orientation, or direction. Instead, such labels are used to reflect, for example, relative location, orientation, or directions. It should also be understood that the singular forms of “a,” “an,” and “the” include plural references unless the context clearly dictates otherwise.

Unless defined otherwise, all technical and scientific terms used herein have the same meaning as commonly understood by persons of ordinary skill in the art to which the invention pertains.

Embodiments of the invention will now be described in greater detail.

Conventional HDDs (e.g., FIG. 9 and accompanying description herein below) typically include one or more data storage disks supported on a hub for rotation by a spindle motor assembly. The one or more data storage disks each have a central opening defining an inner diameter through which a spindle of the spindle motor assembly extends. Each disk is secured at its inner diameter to the hub in a fixed relation with the spindle, and each disk is supported such that its outer diameter is free from contact with other components. When the spindle is rotatably driven by the spindle motor, the one or more data storage disks rotate with the spindle.

In securing the one or more data storage disks to the hub, the disks are alternately stacked with spacer rings on the hub, defining the core of the disk stack. The disks of the disk stack are typically secured onto the hub by a disk clamp that fits over the top of the hub. Conventional HDDs typically use a screw-based disk clamp to secure the one or more data storage disks of the disk pack in place on the hub. The height of the dedicated space required for the screw-based disk clamp takes an amount of length away from the bearing span of the spindle, height that could instead be used to increase bearing span and, thus, gyro performance. Described herein are various embodiments of disk clamps that do not require screws and/or reclaim height-based space increasing bearing span.

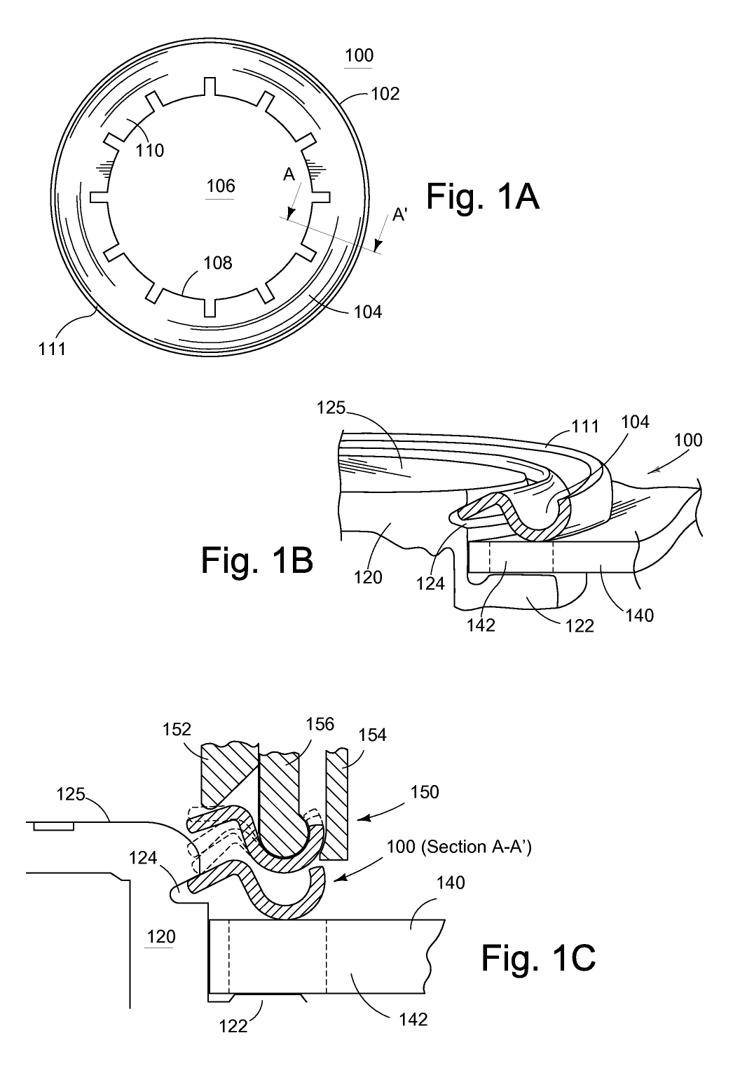

In some embodiments, a disk clamp in accordance with FIG. 1A is provided to secure a disk onto a hub without a separate fastener (e.g., screw). The disk clamp 100 of FIG. 1A may comprise a material having a relatively low thermal expansion coefficient such as a volumetric coefficient no more than 70×10-6 per ° C., such as no more than 55×10-6 per ° C., for example, no more than 40×10-6 per ° C., 35×10-6 per ° C., or 30×10-6 per ° C. In some embodiments, the disk clamp may comprise a material having a relatively low thermal expansion coefficient (e.g., volumetric coefficient) from about 5° C. to about 60° C., the normal operating range for HDDs. In such embodiments, the disk clamp may comprise aluminum or steel (e.g., stainless steel or carbon steel). Plastic may also be used as a material for the disk clamp.

As shown in FIG. 1A, the disk clamp may be an annular disk clamp 100 with an outer perimeter 102, an inner annulus 104, an inner opening 106, and an inner perimeter 108 of the inner opening. The inner opening 106 of the disk clamp further comprises a plurality of flanges 110 extending from a region at or near the innermost portion of the inner annulus 104 and terminating at the inner perimeter 108.

With respect to the plurality of flanges, which flanges are designed to occupy an annular groove of a hub, the plurality of flanges may be evenly spaced about the inner opening 106 of the annular disk clamp 100. In some embodiments, the disk clamp comprises an even number of flanges. In some embodiments, the disk clamp comprises an odd number of flanges. In some embodiments, the disk clamp comprises at least 3, 4, 5, 6, 7, 8, 9, 10, 11, or 12 flanges, or more, such as at least 24, 36, 48 or 60 flanges.

The plurality of flanges 110 may be a plurality of compliant flanges such that a tool, configured to interface with the disk clamp, may be used to manipulate (e.g., bend) the compliant flanges during installation (or removal) of the disk clamp.

Excepting the compliant flanges, the remainder of the disk clamp 100 may be non-compliant. The non-compliant portion of the disk clamp may include a portion of the disk clamp from the outer perimeter 102 of the disk clamp, across the inner annulus 104, and to a point at or near the inner annulus, from which the plurality of flanges extend. Having such a non-compliant portion of the disk clamp allows the disk clamp to firmly clamp a disk in place at a mounting point on the hub. As shown in more detail in FIG. 1B, the inner annulus 104 comprises an annular trough, the bottom of which directly contacts a disk at an inner annulus of the disk, firmly clamping the disk in place at the mounting point on the hub.

Turning to FIG. 1B, disk clamp 100 is shown securing a disk 140 onto a hub 120 without a separate fastener (e.g., screw). As shown, the hub comprises an annular groove 124 configured to accommodate the plurality of flanges 110 of the disk clamp, wherein the annular groove is located in an outer perimeter of the hub, above a mounting point 122 for the disk and below the topmost portion of the hub 125.

The disk clamp 100 of FIG. 1B fits over the topmost portion 125 of the hub when the compliant flanges of the inner opening are bent axially downward (i.e., into an assembly mode). Bending the compliant flanges axially downward includes bending the flanges down in a direction parallel to the central axis of the disk clamp or the spindle axis when the disk clamp is positioned for clamping (e.g. immediately before fitting the inner perimeter of the disk clamp over the out perimeter of the hub).

The disk clamp 100 of FIG. 1B may not fit over the topmost portion 125 of the hub when the plurality of flanges are straightened or relaxed. In such a form, the inner perimeter 108 of the inner opening 106 of disk clamp is less than the outer perimeter of the hub, making it difficult to fit the disk clamp over the hub without the risk of generating particles. When in position (i.e., operable mode) on the hub, the relaxed or straightened flanges of the disk clamp occupy the annular groove of the hub as shown in FIG. 1B.

As further shown in FIG. 1B, inner annulus 104 of the disk clamp comprises an annular trough, the bottom of which sits below each of the outer perimeter and the inner perimeter of the disk clamp, and the bottom of which directly contacts an inner annulus 142 of the disk, clamping the disk to the hub at the mounting point 122. Additionally, FIG. 1B shows that the disk clamp is wholly seated above the disk when clamping the disk onto the hub at the mounting point for the disk. In other words, the entire disk (or entire disk stack [i.e., plurality of disks alternately stacked with spacer rings]) sits below the disk clamp when the disk clamp is clamping the disk onto the hub at the mounting point for the disk. While FIG. 1B shows the disk clamp wholly seated above the disk when clamping the disk onto the hub at the mounting point for the disk, embodiments in which the disk clamp is substantially seated above the disk when clamping the disk onto the hub are also encompassed. In such embodiments, a majority (e.g., ⅔) of the disk clamp may be seated above the disk when clamping the disk onto the hub at the mounting point for the disk.

With respect to the installation (or removal) tool designed to interface with the disk clamp, the tool is operable to pick up the disk clamp, bend the flanges of the inner opening axially downward, lower the disk clamp onto the hub, and/or allow the flanges of the disk clamp to relax or straighten such that the flanges occupy the annular groove of the hub, clamping the disk onto the hub. A cross-section of such a tool is schematically illustrated in FIG. 1C, wherein a first portion 152 of the tool is operable to bend the compliant flanges of the disk clamp axially downward, a second portion 154 of the tool is operable to hold the disk clamp from the outer perimeter, and a third portion 156 of the tool is operable to insert into the inner annulus or trough of the disk clamp and to provide a pivot point about which the inner annulus or trough of the disk clamp may move when bending the compliant flanges axially downward.

With respect to clamping a disk to a hub using the disk clamp of FIGS. 1A, 1B, and/or 1C, such clamping comprises, in some embodiments, lowering the disk to be clamped over the topmost portion of the hub and onto the mounting point of the hub; bending the compliant flanges of the inner opening axially downward; lowering the disk clamp over the topmost portion of the hub and onto an inner annulus of a disk; releasing the compliant flanges, allowing the flanges to relax or straighten into the annular groove of the hub; and clamping the disk to the hub at the mounting point. With respect to unclamping and removing a disk from a hub, such unclamping and removing comprises, in some embodiments, bending the compliant flanges of the inner opening radially downward to remove the flanges from the annular groove of the hub, unclamping the disk; raising the disk clamp over the topmost portion of the hub to remove the disk clamp; and raising the disk over the topmost portion of the hub to remove the disk.

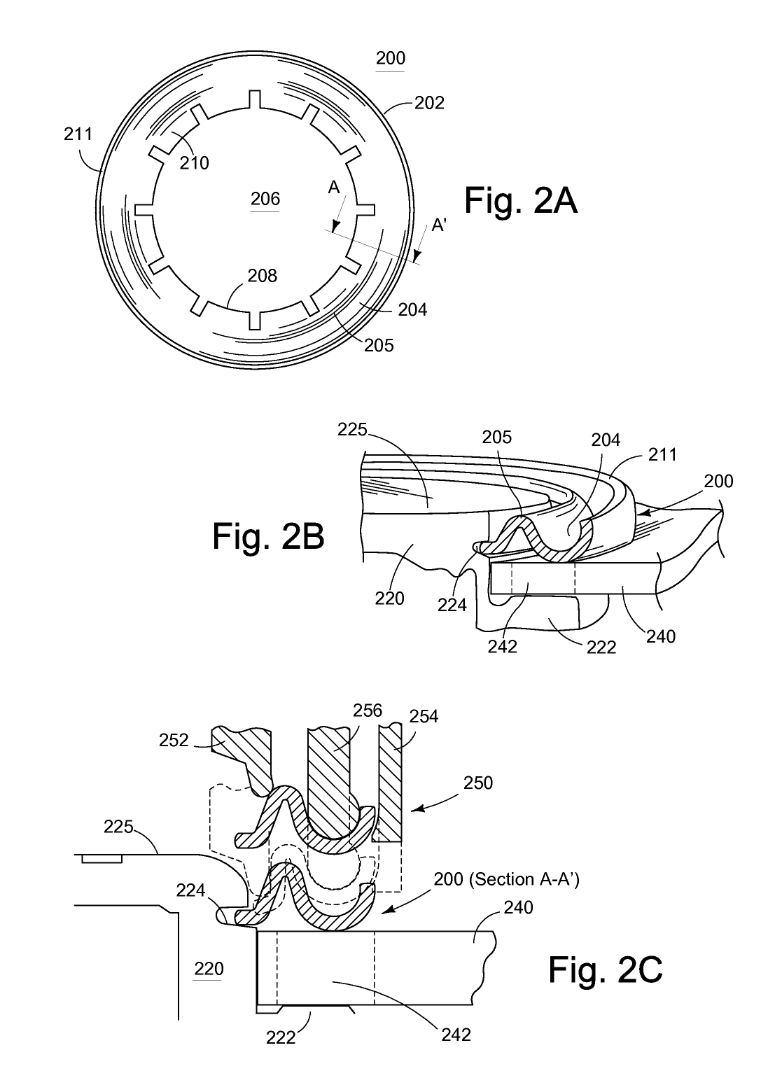

In some embodiments, a disk clamp in accordance with FIG. 2A is provided to secure a disk onto a hub without a separate fastener (e.g., screw). The disk clamp 200 of FIG. 2A may comprise a material having a relatively low thermal expansion coefficient such as a volumetric coefficient no more than 70×10-6 per ° C., such as no more than 55×10-6 per ° C., for example, no more than 40×10-6 per ° C., 35×10-6 per ° C., or 30×10-6 per ° C. In some embodiments, the disk clamp may comprise a material having a relatively low thermal expansion coefficient (e.g., volumetric coefficient) from about 5° C. to about 60° C., the normal operating range for HDDs. In such embodiments, the disk clamp may comprise aluminum or steel (e.g., stainless steel or carbon steel). Plastic may also be used as a material for the disk clamp.

As shown in FIG. 2A, the disk clamp may be an annular disk clamp 200 with an outer perimeter 202, a first inner annulus 204, a second inner annulus 205, an inner opening 206, and an inner perimeter 208 of the inner opening. The inner opening 206 of the disk clamp further comprises a plurality of flanges 210 extending from a region at or near the innermost portion of the first inner annulus 204 and terminating at the inner perimeter 208. The plurality of flanges comprises the second inner annulus 205 as described in more detail below.

With respect to the plurality of flanges, which flanges are designed to occupy an annular groove of a hub, the plurality of flanges may be evenly spaced about the inner opening 206 of the annular disk clamp 200. In some embodiments, the disk clamp comprises an even number of flanges. In some embodiments, the disk clamp comprises an odd number of flanges. In some embodiments, the disk clamp comprises at least 3, 4, 5, 6, 7, 8, 9, 10, 11, or 12 flanges, or more, such as at least 24, 36, 48 or 60 flanges.

The plurality of flanges 210 may be a plurality of compliant flanges such that a tool, configured to interface with the disk clamp, may be used to manipulate (e.g., bend) the compliant flanges during installation (or removal) of the disk clamp. As shown in more detail in FIG. 2B, the plurality of flanges comprise the second inner annulus 205, which includes an annular peak, the inner and outer walls of which approach each other (via compression) when the tool is used to manipulate (e.g., bend) the compliant flanges during installation (or removal) of the disk clamp.

Excepting the compliant flanges, the remainder of the disk clamp 200 may be non-compliant. The non-compliant portion of the disk clamp may include a portion of the disk clamp from the outer perimeter 202 of the disk clamp, across the first inner annulus 204, and to a point at or near the first inner annulus, from which the plurality of flanges extend. Having such a non-compliant portion of the disk clamp allows the disk clamp to firmly clamp a disk in place at a mounting point on the hub. As shown in more detail in FIG. 2B, the first inner annulus 204 comprises an annular trough, the bottom of which directly contacts a disk at an inner annulus of the disk, firmly clamping the disk in place at the mounting point on the hub.

Turning to FIG. 1B, disk clamp 200 is shown securing a disk 240 onto a hub 220 without a separate fastener (e.g., screw). As shown, the hub comprises an annular groove 224 configured to accommodate the plurality of flanges 210 of the disk clamp, wherein the annular groove is located in an outer perimeter of the hub, above a mounting point 222 for the disk and below the topmost portion of the hub 225.

The disk clamp 200 of FIG. 2B fits over the topmost portion 225 of the hub when the compliant flanges of the inner opening are bent radially outward toward the outer perimeter of the disk clamp (i.e., into an assembly mode). Bending the compliant flanges radially outward includes bending the flanges out in a direction parallel to a radius of the disk clamp or an underlying disk when the disk is positioned for clamping (e.g. immediately before fitting the inner perimeter of the disk clamp over the out perimeter of the hub). Bending the compliant flanges radially outward further includes compressing the inner and outer walls of the annular peak of the second inner annulus 205 when the disk is positioned for clamping (e.g. immediately before fitting the inner perimeter of the disk clamp over the out perimeter of the hub).

The disk clamp 200 of FIG. 2B may not fit over the topmost portion 225 of the hub when the plurality of flanges are straightened or relaxed. In such a form, the inner perimeter 208 of the inner opening 206 of disk clamp is less than the outer perimeter of the hub, making it difficult to fit the disk clamp over the hub without the risk of generating particles. When in position (i.e., operable mode) on the hub, the relaxed or straightened flanges of the disk clamp occupy the annular groove of the hub as shown in FIG. 2B.

As further shown in FIG. 2B, the first inner annulus 204 of the disk clamp comprises an annular trough, the bottom of which sits below each of the outer perimeter and the inner perimeter of the disk clamp, and the bottom of which directly contacts an inner annulus 242 of the disk, clamping the disk to the hub at the mounting point 222. Additionally, FIG. 2B shows that the disk clamp is wholly seated above the disk when clamping the disk onto the hub at the mounting point for the disk. In other words, the entire disk (or entire disk stack [i.e., plurality of disks alternately stacked with spacer rings]) sits below the disk clamp when the disk clamp is clamping the disk onto the hub at the mounting point for the disk. While FIG. 2B shows the disk clamp wholly seated above the disk when clamping the disk onto the hub at the mounting point for the disk, embodiments in which the disk clamp is substantially seated above the disk when clamping the disk onto the hub are also encompassed. In such embodiments, a majority (e.g., ⅔) of the disk clamp may be seated above the disk when clamping the disk onto the hub at the mounting point for the disk.

With respect to the installation (or removal) tool designed to interface with the disk clamp, the tool is operable to pick up the disk clamp, bend the flanges of the inner opening radially outward toward the outer perimeter of the disk clamp, lower the disk clamp onto the hub, and/or allow the flanges of the disk clamp to relax or straighten such that the flanges occupy the annular groove of the hub, clamping the disk onto the hub. A cross-section of such a tool is schematically illustrated in FIG. 2C, wherein a first portion 252 of the tool is operable to bend the compliant flanges of the disk clamp radially outward, a second portion 254 of the tool is operable to hold the disk clamp from the outer perimeter, and a third portion 256 of the tool is operable to insert into the first inner annulus 204 or trough of the disk clamp and to provide a pivot point about which the first inner annulus 204 or trough of the disk clamp may move when bending the compliant flanges radially outward toward the outer perimeter of the disk clamp.

With respect to clamping a disk to a hub using the disk clamp of FIGS. 2A, 2B, and/or 2C, such clamping comprises, in some embodiments, lowering the disk to be clamped over the topmost portion of the hub and onto the mounting point of the hub; bending the compliant flanges of the inner opening radially outward; lowering the disk clamp over the topmost portion of the hub and onto an inner annulus of a disk; releasing the compliant flanges, allowing the flanges to relax or straighten into the annular groove of the hub; and clamping the disk to the hub at the mounting point. With respect to unclamping and removing a disk from a hub, such unclamping and removing comprises, in some embodiments, bending the compliant flanges of the inner opening radially outward to remove the flanges from the annular groove of the hub, unclamping the disk; raising the disk clamp over the topmost portion of the hub to remove the disk clamp; and raising the disk over the topmost portion of the hub to remove the disk.

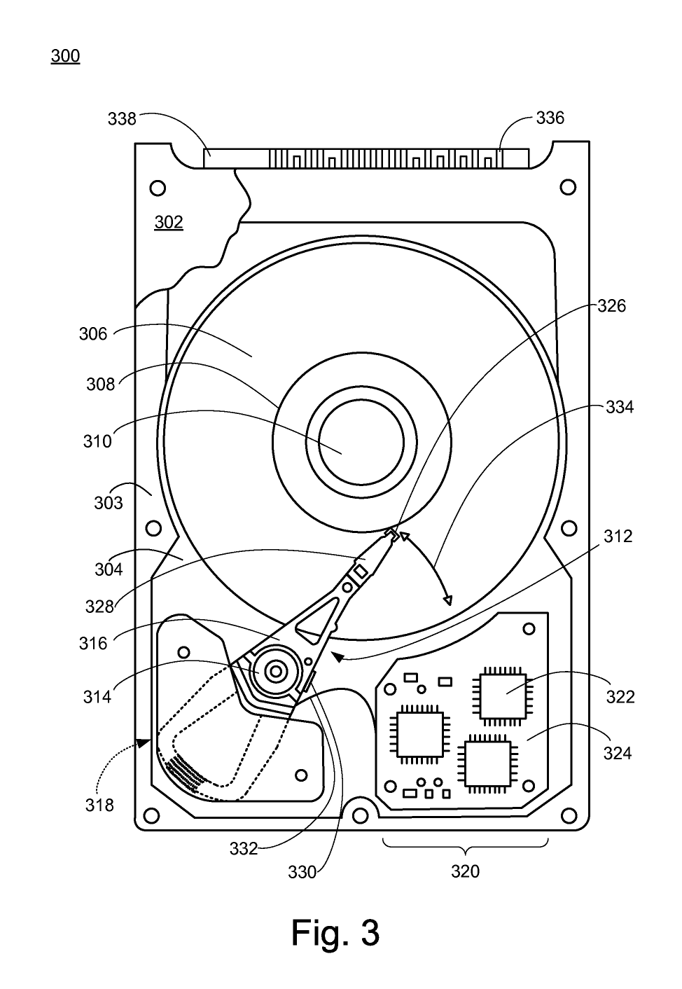

FIG. 3 is a plan view of a hard disk drive 300, which hard disk drive may use the a disk clamp described herein. Hard disk drive 300 may include a housing assembly comprising a cover 302 that mates with a base deck having a frame 303 and a floor 304, which housing assembly provides a protective space for various hard disk drive components. The hard disk drive 300 includes one or more data storage disks 306 of computer-readable data storage media. Typically, both of the major surfaces of each data storage disk 306 include a plurality of concentrically disposed tracks for data storage purposes. Each data storage disk 306 is mounted on a hub 308, which in turn is rotatably interconnected with the base deck and/or cover 302. Multiple data storage disks 306 are typically mounted in vertically spaced and parallel relation on the hub 308. A spindle motor assembly 310 rotates the data storage disks 306.

The hard disk drive 300 also includes an actuator arm assembly 312 that pivots about a pivot bearing 314, which in turn is rotatably supported by the base deck and/or cover 302. The actuator arm assembly 312 includes one or more individual rigid actuator arms 316 that extend out from near the pivot bearing 314. Multiple actuator arms 316 are typically disposed in vertically spaced relation, with one actuator arm 316 being provided for each major data storage surface of each data storage disk 306 of the hard disk drive 300. Other types of actuator arm assembly configurations could be utilized as well, an example being an “E” block having one or more rigid actuator arm tips, or the like, that cantilever from a common structure. Movement of the actuator arm assembly 312 is provided by an actuator arm drive assembly, such as a voice coil motor 318 or the like. The voice coil motor 318 is a magnetic assembly that controls the operation of the actuator arm assembly 312 under the direction of control electronics 320. The control electronics 320 may include a plurality of integrated circuits 322 coupled to a printed circuit board 324. The control electronics 320 may be coupled to the voice coil motor assembly 318, a slider 326, or the spindle motor assembly 310 using interconnects that can include pins, cables, or wires (not shown).

A load beam or suspension 328 is attached to the free end of each actuator arm 316 and cantilevers therefrom. Typically, the suspension 328 is biased generally toward its corresponding data storage disk 306 by a spring-like force. The slider 326 is disposed at or near the free end of each suspension 328. What is commonly referred to as the read-write head (e.g., transducer) is appropriately mounted as a head unit (not shown) under the slider 326 and is used in hard disk drive read/write operations. The head unit under the slider 326 may utilize various types of read sensor technologies such as anisotropic magnetoresistive (AMR), giant magnetoresistive (GMR), tunneling magnetoresistive (TuMR), other magnetoresistive technologies, or other suitable technologies.

The head unit under the slider 326 is connected to a preamplifier 330, which is interconnected with the control electronics 320 of the hard disk drive 300 by a flex cable 332 that is typically mounted on the actuator arm assembly 312. Signals are exchanged between the head unit and its corresponding data storage disk 906 for hard disk drive read/write operations. In this regard, the voice coil motor 318 is utilized to pivot the actuator arm assembly 312 to simultaneously move the slider 326 along a path 334 and across the corresponding data storage disk 306 to position the head unit at the appropriate position on the data storage disk 306 for hard disk drive read/write operations.

When the hard disk drive 300 is not in operation, the actuator arm assembly 312 is pivoted to a “parked position” to dispose each slider 326 generally at or beyond a perimeter of its corresponding data storage disk 306, but in any case in vertically spaced relation to its corresponding data storage disk 306. In this regard, the hard disk drive 300 includes a ramp assembly (not shown) that is disposed beyond a perimeter of the data storage disk 306 to both move the corresponding slider 326 vertically away from its corresponding data storage disk 306 and to also exert somewhat of a retaining force on the actuator arm assembly 312.

Exposed contacts 336 of a drive connector 338 along a side end of the hard disk drive 300 may be used to provide connectivity between circuitry of the hard disk drive 300 and a next level of integration such as an interposer, a circuit board, a cable connector, or an electronic assembly. The drive connector 338 may include jumpers (not shown) or switches (not shown) that may be used to configure the hard disk drive 300 for user specific features or configurations. The jumpers or switches may be recessed and exposed from within the drive connector 338.

As such, provided herein is an apparatus, comprising a plurality of compliant flanges extending to form an inner perimeter of an inner opening of an annular disk clamp, wherein the plurality of compliant flanges has an assembly mode and an operable mode; an annular groove in an outer perimeter of a hub configured to receive the plurality of flanges of the annular disk clamp; and a mounting point on the hub for at least one disk, wherein the inner perimeter of the annular disk clamp is configured to fit over the outer perimeter of the hub when the plurality of flanges is in the assembly mode, and wherein the annular disk clamp is wholly seated above the at least one disk when clamping the at least one disk onto the hub at the mounting point for the at least one disk. In some embodiments, the plurality of flanges is configured to occupy the annular groove of the hub when the plurality of flanges is the operable mode. In some embodiments, an outer annulus of the disk clamp is non-compliant. In some embodiments, the outer annulus of the disk clamp applies a uniform pressure on an inner annulus of the at least one disk directly overlying the mounting point. In some embodiments, the at least one disk tops a disk stack comprising a plurality of disks alternately stacked with spacer rings.

Also provided herein is an apparatus, comprising a plurality of compliant flanges extending to form an inner perimeter of an inner opening of an annular disk clamp; an annular groove in an outer perimeter of a hub configured to receive the plurality of flanges of the annular disk clamp; and a mounting point on the hub for at least one disk, wherein the inner perimeter of the annular disk clamp is configured to fit over the outer perimeter of the hub when each flange of the plurality of flanges is bent radially outward toward an outer perimeter of the annular disk clamp, and wherein the annular disk clamp is wholly seated above the at least one disk when clamping the at least one disk onto the hub at the mounting point for the at least one disk. In some embodiments, the plurality of flanges is configured to occupy the annular groove of the hub when each flange of the plurality of flanges is relaxed. In some embodiments, an outer annulus of the disk clamp is non-compliant. In some embodiments, the outer annulus of the disk clamp applies a uniform pressure on an inner annulus of the at least one disk directly overlying the mounting point. In some embodiments, the at least one disk tops a disk stack comprising a plurality of disks alternately stacked with spacer rings.

Also provided herein is an apparatus, comprising: a plurality of compliant flanges extending to form an inner perimeter of an inner opening of a disk clamp; an annular groove in an outer perimeter of a hub configured to receive the plurality of flanges of the disk clamp; and a mounting point on the hub for at least one disk, wherein the inner perimeter of the disk clamp is configured to fit over the outer perimeter of the hub when each flange of the plurality of flanges is bent axially downward, and wherein the disk clamp is substantially seated above the at least one disk when clamping the at least one disk onto the hub at the mounting point for the at least one disk. In some embodiments, the plurality of flanges is configured to occupy the annular groove of the hub when each flange of the plurality of flanges is relaxed. In some embodiments, an outer annulus of the disk clamp is non-compliant. In some embodiments, the outer annulus of the disk clamp applies a uniform pressure on an inner annulus of the at least one disk directly overlying the mounting point. In some embodiments, the at least one disk tops a disk stack comprising a plurality of disks alternately stacked with spacer rings.

Also provided herein is an apparatus, comprising a plurality of flanges extending to form an inner perimeter of an inner opening of an annular disk clamp; and an annular groove in an outer perimeter of a hub configured to receive the plurality of flanges of the annular disk clamp, wherein the disk clamp is seated above at least one disk when clamping the at least one disk onto the hub at a mounting point for the at least one disk. In some embodiments, the plurality of flanges are compliant. In some embodiments, the inner perimeter of the annular disk clamp is configured to fit over the outer perimeter of the hub when each flange of the plurality of flanges is bent radially outward toward an outer perimeter of the annular disk clamp. In some embodiments, the plurality of flanges is configured to occupy the annular groove of the hub when each flange of the plurality of flanges is relaxed. In some embodiments, the inner perimeter of the annular disk clamp is configured to fit over the outer perimeter of the hub when each flange of the plurality of flanges is bent axially downward. In some embodiments, the plurality of flanges is configured to occupy the annular groove of the hub when each flange of the plurality of flanges is relaxed. In some embodiments, an outer annulus of the annular disk clamp is non-compliant. In some embodiments, the outer annulus of the annular disk clamp applies a uniform pressure on an inner annulus of the at least one disk directly overlying the mounting point. In some embodiments, the at least one disk tops a disk stack comprising a plurality of disks alternately stacked with spacer rings. In some embodiments, the annular disk clamp comprises plastic, aluminum, or steel.

While the invention has been described and/or illustrated by means of various embodiments and/or examples, and while these embodiments and/or examples have been described in considerable detail, it is not the intention of the applicant(s) to restrict or in any way limit the scope of the invention to such detail. Additional adaptations and/or modifications of embodiments of the invention may readily appear to persons having ordinary skill in the art to which the invention pertains, and, in its broader aspects, the invention may encompass these adaptations and/or modifications. Accordingly, departures may be made from the foregoing embodiments and/or examples without departing from the scope of the invention, which scope is limited only by the following claims when appropriately construed.

1. An apparatus, comprising:
a plurality of compliant flanges extending into an inner annulus of an annular disk clamp;
an annular groove in an outer perimeter of a hub configured to receive the plurality of flanges of the annular disk clamp; and
a mounting point on the hub for at least one disk,
wherein the inner perimeter of the annular disk clamp is configured to fit over the outer perimeter of the hub when the plurality of flanges is bent axially downward, and
wherein the annular disk clamp is wholly seated above the at least one disk when clamping the at least one disk onto the hub at the mounting point for the at least one disk.

2. The apparatus of claim 1, wherein the plurality of flanges is configured to occupy the annular groove of the hub when the plurality of flanges is an operable mode.

3. The apparatus of claim 1, wherein an outer annulus of the disk clamp is non-compliant.

4. The apparatus of claim 3, wherein the outer annulus of the disk clamp applies a uniform pressure on an inner annulus of the at least one disk directly overlying the mounting point.

5. (canceled)

6. An apparatus, comprising:
a disk clamp comprising a plurality of compliant flanges extending into an inner annulus of the disk clamp; and
a hub comprising an annular groove in an outer perimeter configured to receive the plurality of flanges of the disk clamp, wherein the inner perimeter of the disk clamp is configured to fit over the outer perimeter of the hub when each flange of the plurality of flanges is bent axially downward.

7. The apparatus of claim 6, wherein the plurality of flanges is configured to occupy the annular groove of the hub when each flange of the plurality of flanges is relaxed.

8. The apparatus of claim 6, wherein an outer annulus of the disk clamp is non-compliant.

9. The apparatus of claim 8, wherein the outer annulus of the disk clamp applies a uniform pressure on an inner annulus of at least one disk directly overlying a mounting point of the hub.

10. (canceled)

11. An apparatus, comprising:
an inner annulus; and
a plurality of flanges extending into the inner annulus, wherein the plurality of flanges are configured to occupy an annular groove in an outer perimeter of a hub thereby clamping at least one disk onto the hub at a mounting point for the at least one disk.

12. The apparatus of claim 11, wherein the plurality of flanges are compliant.

13. The apparatus of claim 11, the inner perimeter is configured to fit over the outer perimeter of the hub when each flange of the plurality of flanges is bent radially outward.

14-15. (canceled)

16. The apparatus of claim 15, wherein the plurality of flanges occupy the annular groove of the hub when each flange of the plurality of flanges is relaxed.

17. The apparatus of claim 11, wherein an outer annulus of the annular disk clamp is non-compliant.

18. The apparatus of claim 11, wherein an annular trough of the inner annulus applies a uniform pressure on an inner annulus of the at least one disk directly overlying the mounting point.

19. (canceled)

20. The apparatus of claim 11, wherein the annular disk clamp comprises plastic, aluminum, or steel.

21. The apparatus of claim 11, further comprising an annular peak.

22. The apparatus of claim 1, further comprising an annular trough of the annular disk clamp with a bottom in contact with the at least one disk.

23. The apparatus of claim 22, further comprising an annular peak of the annular disk clamp.

24. The apparatus of claim 6, wherein the inner annulus of the disk clamp comprises an annular trough with a bottom in contact with at least one disk.

25. The apparatus of claim 24, further comprising the disk clamp further comprises an annular peak.
